(19) United States
(12) Patent Application Publication
(10) Pub. No.: US 2012/0019156 A1
(43) Pub. Date: Jan. 26, 2012

(54) LED STRING DRIVER WITH NON-DISSIPATIVE REACTANCE BALANCER

(75) Inventor: Xiaoping JIN, Orange, CA (US)

(73) Assignee: MICROSEMI CORPORATION, Garden Grove, CA (US)

(21) Appl. No.: 13/175,902

(22) Filed: Jul. 4, 2011

Related U.S. Application Data
(60) Provisional application No. 61/366,571, filed on Jul. 22, 2010.

(51) Int. Cl. H05B 37/02

(52) U.S. Cl. 315/187; 315/185 R; 315/192

(57) ABSTRACT

A solid state lighting arrangement constituted of: a power source providing a current which is discontinuous in at least one direction; a plurality of light emitting diode (LED) strings arranged to receive the provided current from the power source; and a plurality of reactance elements, each of the plurality of reactance elements arranged in series with a particular one of the plurality of LED strings, such that current flowing from the power source through each of the LED strings creates a voltage drop across the series arranged reactance element, wherein the voltage drop across each of the series arranged reactance elements responsive to the discontinuous current is at least 10 times greater than the maximum difference between the voltage drops among the plurality of LED strings.

### CROSS-REFERENCE TO RELATED APPLICATIONS

This application claims priority from U.S. Provisional Patent Application Ser. No. 61/366,571 filed Jul. 22, 2010 entitled “LED String Driver with Non-Dissipative Impedance Balancer”, the entire contents of which is incorporated herein by reference.

### BACKGROUND OF THE INVENTION

The present invention relates to the field of solid state lighting, and in particular to a plurality of LED strings coupled to a common power source in parallel and comprising a non-dissipative current balancer.

Light emitting diodes (LEDs) and in particular high intensity and medium intensity LED strings are rapidly coming into wide use for lighting applications. LEDs with an overall high luminance are useful in a number of applications including backlighting for liquid crystal display (LCD) based monitors and televisions, collectively hereinafter referred to as a matrix display, as well as for general lighting applications.

In a large LCD matrix display, and in large solid state lighting applications, such as street lighting, typically the LEDs are supplied in a plurality of strings of serially connected LEDs, at least in part so that in the event of failure of one string at least some light is still output. The constituent LEDs of each LED string thus share a common current.

In order to supply a white light, one of two basic techniques are commonly used. In a first technique strings of “white” LEDs are utilized, the white LEDs typically comprising a blue LED with a phosphor which absorbs the blue light emitted by the LED and emits a white light. In a second technique individual strings of colored LEDs are placed in proximity so that in combination their light is seen a white light. Often, two strings of green LEDs are utilized to balance each single red and blue LED string.

LEDs providing high luminance exhibit a range of forward voltage drops, denoted V_{f}, and their luminance is primarily a function of current. For example, one manufacturer of LEDs suitable for use with a portable computer, such as a notebook computer, indicates that V_{f} for a particular high luminance white LED ranges from 2.95 volts to 3.65 volts at 20 mA and an LED junction temperature of 25° C., thus exhibiting a variance in V_{f} of greater than ±10%. Furthermore, the luminance of the LEDs vary as a function of junction temperature and age, typically exhibiting a reduced luminance as a function of current with increasing temperature and increasing age. In order to provide backlight illumination for a portable computer with an LCD matrix display of at least 25 cm measured diagonally, at least 20, and typically in excess of 40, LEDs are required. In order to provide street lighting, in certain applications over 100 LEDs are required.

In order to provide a balanced overall luminance, it is important to control the current of the various LED strings to be approximately equal. In one embodiment a power source is supplied for each LED string, and the voltage of the power source is controlled in a closed loop to ensure that the voltage output of the power source is consonant with the voltage drop of the LED string; however the requirement for a power source for each LED string is quite costly.

In another embodiment, as described in U.S. Patent Application Publication US 2007/0195025 to Korcharz et al, entitled “Voltage Controlled Backlight Driver” and published Aug. 23, 2007, the entire contents of which is incorporated herein by reference, this is accomplished by a controlled dissipative element placed in series with each of the LED strings. In another embodiment, binning is required, in which LEDs are sorted, or binned, based on their electrical and optical characteristics. Thus, in order to operate a plurality of like colored LED strings from a single power source, at a common current, either binning of the LEDs to be within a predetermined range of V_{f} is required, or a dissipative element of the aforementioned patent application, must be supplied to drop the voltage difference between the strings caused by the differing V_{f} values so as to produce an equal current through each of the LED strings. Either of these solutions adds to cost and/or wasted energy.

What is needed, and not supplied by the prior art, is a balancing method which does not present dissipative losses.

### SUMMARY OF THE INVENTION

Accordingly, it is a principal object of the present invention to overcome at least some of the disadvantages of the prior art. This is provided in certain embodiments by a solid state lighting arrangement exhibiting a plurality of LED strings receiving power from a single power source, the single power source providing a discontinuous current. For each LED string a reactance element, constituted of a capacitor or inductor, is provided, the voltage drop across the reactance element being significant in relation to the difference in voltage drop across the various LED strings, and wherein the reactance of the various reactance elements are matched. In one particular embodiment the voltage drop across the reactance elements is at least 10 times greater than the difference between the voltage drops of the various LED strings. In another particular embodiment the impedance of the various reactance elements are matched to be within 1%.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level schematic diagram of an exemplary embodiment of a solid state lighting arrangement with a non-dissipative balancer constituted of capacitors, each of the capacitors associated with a pair of anti-parallel connected LED strings;

FIG. 2 illustrates a high level schematic diagram of an exemplary embodiment of a solid state lighting arrangement with a non-dissipative balancer constituted of capacitors, further comprising a full wave rectifier associated with each LED string;

FIG. 3 illustrates a high level schematic diagram of an exemplary embodiment of a solid state lighting arrangement with a non-dissipative balancer constituted of inductors, each of the inductors associated with a pair of anti-parallel connected LED strings;

FIG. 4 illustrates a high level schematic diagram of an exemplary embodiment of a solid state lighting arrangement with a non-dissipative balancer constituted of inductors, wherein power is supplied as a discontinuous direct current; and

FIG. 5 illustrates a high level flow chart of an exemplary method of non-dissipative balanced driving for LED strings.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. The term winding is particularly meant to mean a winding of electrically conducting wire forming an inductor. The winding may form a stand alone inductor, or be magnetically coupled to another winding forming a transformer.

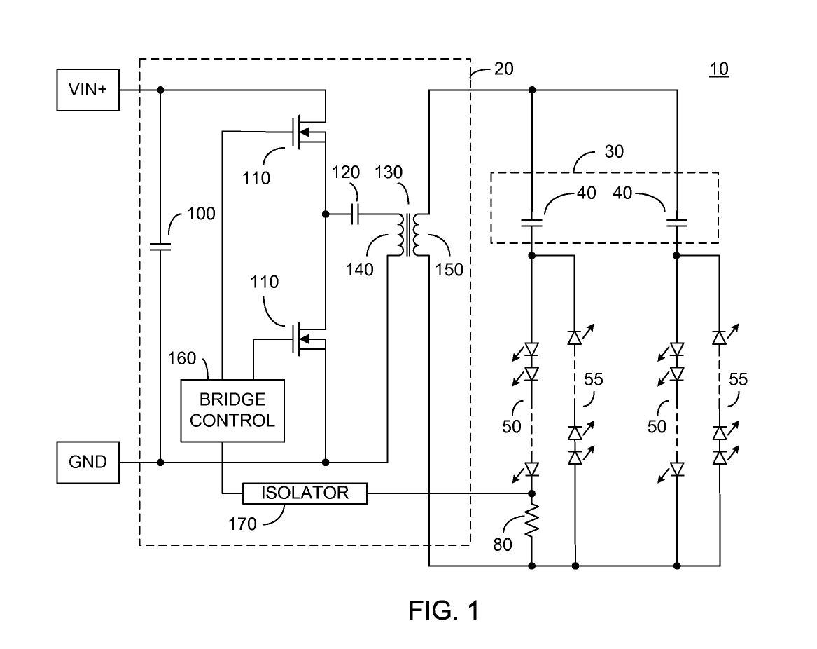

FIG. 1 illustrates a high level schematic diagram of an exemplary embodiment of a solid state lighting arrangement 10 driven by an AC signal generated by a half-bridge converter 20, with a non-dissipative balancer 30 constituted of a plurality of capacitors 40, each of capacitors 40 associated with a pair of LED strings 50, 55, connected in an anti-parallel arrangement. Solid state lighting arrangement 10 further comprises a sense resistor 80. Only a single sense resistor 80 is shown, however a plurality of sense resistors may be supplied without exceeding the scope.

Half-bridge converter 20 comprises: an input capacitor 100; a first and a second electronically controlled switch 110, each illustrated without limitation for ease of understanding as an NMOSFET; a coupling capacitor 120; a transformer 130 exhibiting a primary winding 140 and a secondary winding 150; a bridge control circuit 160; and an isolation circuit 170. Half-bridge converter 20 is arranged to receive a DC voltage across a pair of leads, respectively denoted VIN+ and GND.

Lead VIN+ is connected to a first end of input capacitor 100 and to a first terminal of first electronically controlled switch 110, illustrated without limitation as the drain terminal. A second terminal of first electronically controlled switch 110, illustrated without limitation as the source terminal, is connected to a first end of coupling capacitor 120 and to a first terminal of second electronically controlled switch 110, illustrated without limitation as the drain terminal. Lead GND is connected to a second end of input capacitor 100, to a second terminal of second electronically controlled switch 110, illustrated without limitation as the source terminal, and to a first end of primary winding 140 of transformer 130. A second end of primary winding 140 is connected to a second end of coupling capacitor 120. The control terminal of each of first and second electronically controlled switches 110, illustrated without limitation as the gate terminals, are connected to respective outputs of bridge control circuit 160.

A first end of secondary winding 150 of transformer 130 is connected to a first end of each capacitor 40 of non-dissipative balancer 30, and a second end of each capacitor 40 is connected to the anode of a particular LED string 50 and to the cathode of a respective anti-parallel connected LED string 55. The cathode end of one LED string 50 is connected to a first end of sense resistor 80 and to a first end of isolation circuit 170, and a second end of sense resistor 80 is connected to a second end of secondary winding 150. The cathode end of each of the remaining LED strings 50, and the anode end of each of the associated remaining anti-parallel connected LED strings 55, is connected to the second end of secondary wining 150. A second end of isolating circuit 170 is connected to an input of bridge control circuit 160.

In operation, half-bridge converter 20 produces an alternating current by alternately opening and closing first and second electronically controlled switches 110, and the alternating current appears across secondary winding 150 of transformer 130. The alternating current is passed by capacitors 40, and thus each LED string 50 and anti-parallel LED string 55 are lit, responsive to the polarity of the alternating current.

The reactance of the capacitors 40 are selected to provide a voltage drop there across, at the target alternating current frequency, whose value is preferably at least 10 times greater than the maximum difference between the voltage drops among the plurality of LED strings 50, 55. Thus, any difference in voltage drop across the plurality of LED strings 50, 55 may be neglected in comparison to the voltage drop across capacitors 40 of non-dissipative balancer 30. Preferably, the reactance of the various capacitors 40 of non-dissipative balancer 30 are within 1% of each other, thus ensuring a tight balance between the current flowing through the various LED strings 50, 55, whose value is thus primarily a function of the actual reactance of the various capacitors 40. In further detail, in a non-limiting example in which the forward operating voltage difference between the various LED strings 50, or 55, is 10% of the nominal forward operating voltage, more than a 50% LED current difference would result in the event that the LED strings 50, 55 were directly connected in parallel to a common supply source. Selecting capacitors 40 to exhibit a reactance with a voltage drop of at least 10 times the maximum forward operating voltage difference between the LED strings 50, or 55 results in a current difference in the range of 9-10%, since the voltage drop across the capacitors 40 exhibits the same voltage difference as the LED strings, so that the serial combination of voltage drops is equal to the common supply source voltage. Current through each of the capacitors 40 are thus within 10% of each other, since the voltage drops across like capacitors 40 are within 10% of each other.

Bridge control circuit 160 receives a feedback of the actual current flow through sense resistor 80, and controls the operation, particularly the timing, of first and second electronically controlled switches 110 so that the current flow through sense resistor 80 meets the target current value. The balance of the LED strings 50 for which sense resistor 80 is not provided are forced by the operation of non-dissipative balancer 30 to exhibit the same current flow value.

A particular half-bridge converter 20 has been illustrated, however this is not meant to be limiting in any way, and other converter structures, such as full bridge and push pull converters, without limitation, may be substituted without exceeding the scope.

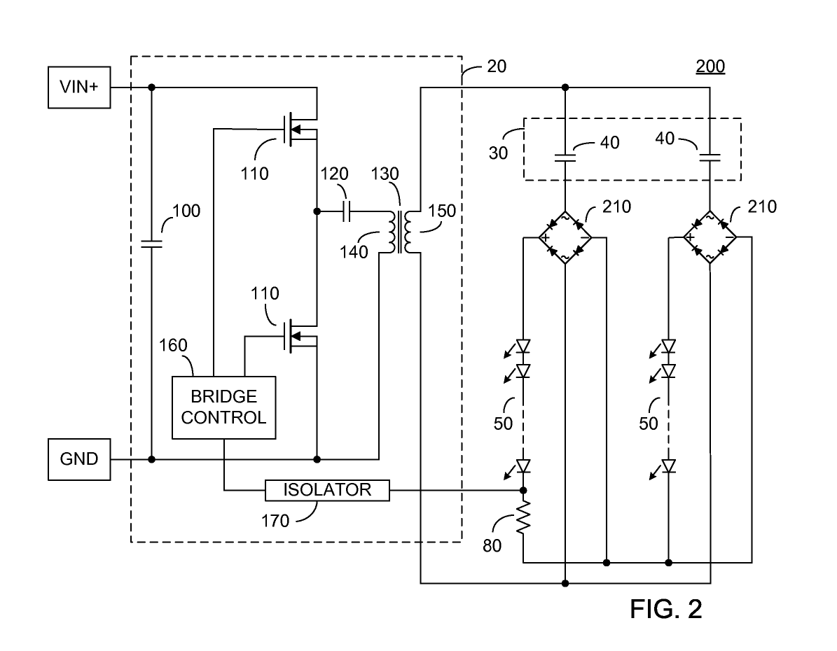

FIG. 2 illustrates a high level schematic diagram of an exemplary embodiment of a solid state lighting arrangement 200 driven by an AC signal generated by a half-bridge converter 20 with a non-dissipative balancer 30 constituted of a plurality of capacitors 40, further comprising a full wave rectifier 210 associated with each of a plurality of LED strings 50. Solid state lighting arrangement 200 further comprises a sense resistor 80. Only a single sense resistor 80 is shown, however a plurality of sense resistors may be supplied without exceeding the scope.

Half-bridge converter 20 is constituted as described above in relation to FIG. 1, and in the interest of brevity is not further detailed.

A first end of secondary winding 150 of transformer 130 is connected to a first end of each capacitor 40 of non-dissipative balancer 30, and a second end of each capacitor 40 is connected to a first alternating current input of a respective full wave rectifier 210. A second alternating current input of each of the respective full wave rectifiers 210 is connected to a second end of secondary winding 150 of transformer 130. The positive lead of each full wave rectifier 210 is connected to the anode end of a respective LED string 50. The cathode end of one LED string 50 is connected to a first end of sense resistor 80 and to a first end of isolation circuit 170, and a second end of sense resistor 80 is connected to the negative lead of the respective full wave rectifier 210. The cathode end of each of the remaining LED strings 50 is connected to the negative lead of the respective full wave rectifier 210, the negative leads of the full wave rectifiers 210 being tied together. As described above in relation to FIG. 1, a second end of isolating circuitry 170 is connected to an input of bridge control circuit 160.

In operation, solid state lighting arrangement 200 is in all respects similar to solid state lighting arrangement 10 of FIG. 1, with the exception that a full wave rectifier 210 is provided in place of the anti-parallel LED string 55, to allow for operation on each half of the alternating current cycle.

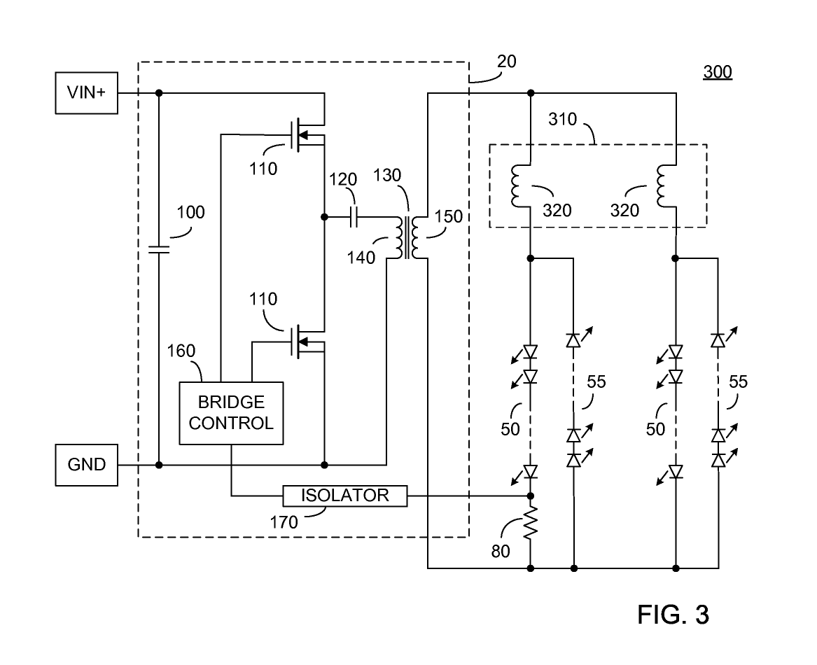

FIG. 3 illustrates a high level schematic diagram of an exemplary embodiment of a solid state lighting arrangement 300 driven by an AC signal generated by a half-bridge converter 20 with a non-dissipative balancer 310 constituted of a plurality of inductors 320, each of inductors 320 associated with a pair of LED strings 50, 55, connected in an anti-parallel arrangement. Solid state lighting arrangement 300 further comprises a sense resistor 80. Only a single sense resistor 80 is shown, however a plurality of sense resistors may be supplied without exceeding the scope.

Solid state lighting arrangement 300 is in all respects similar to solid state lighting arrangement 10 of FIG. 1, with the substitution of non-dissipative balancer 310 for non-dissipative balancer 30, and in the interest of brevity is not further detailed. In operation, inductors 320 provide the reactance described above in relation to capacitors 40, and their values are similarly selected. Non-dissipative balancer 310 may similarly be substituted for non-dissipative balancer 30 in solid state lighting arrangement 200, without exceeding the scope.

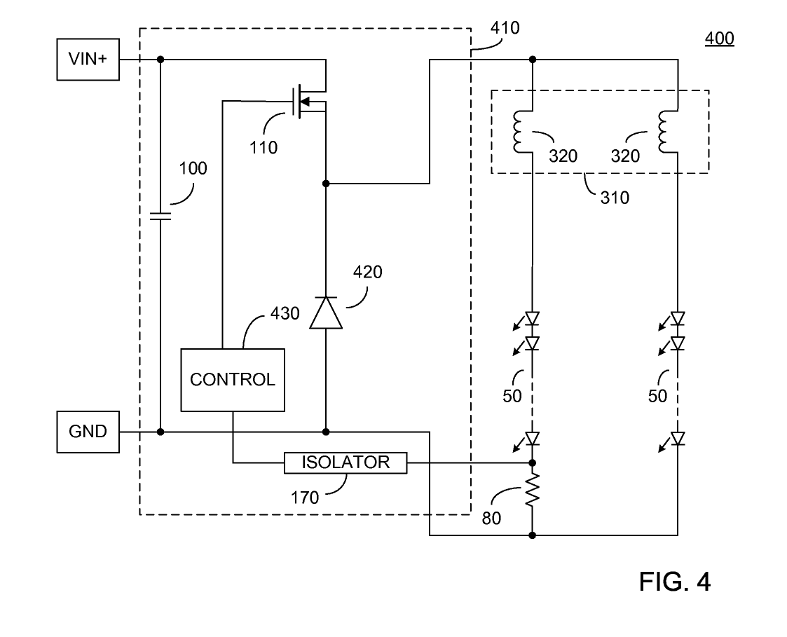

FIG. 4 illustrates a high level schematic diagram of an exemplary embodiment of a solid state lighting arrangement 400 driven by a discontinuous DC signal generated by a buck converter 410 with a non-dissipative balancer 310 constituted of a plurality of inductors 320, each of inductors 320 associated with a single LED string 50. Solid state lighting arrangement 400 further comprises a sense resistor 80. Only a single sense resistor 80 is shown, however a plurality of sense resistors may be supplied without exceeding the scope.

Buck converter 410 comprises an input capacitor 100; an electronically controlled switch 110, illustrated without limitation as an NMOSFET; a unidirectional electronic valve 420, illustrated without limitation as a diode; a control circuitry 430; and an isolation circuit 170. Buck converter 410 is arranged to receive a DC voltage across a pair of leads, respectively denoted VIN+ and GND.

Lead VIN+ is connected to a first end of input capacitor 100 and to a first terminal of electronically controlled switch 110, illustrated without limitation as the drain terminal. A second terminal of electronically controlled switch 110, illustrated without limitation as the source terminal, is connected to the cathode of unidirectional electronic valve 420 and to a first end of each inductor 320 of non-dissipative balancer 310. The anode of unidirectional electronic valve 420 is connected to a second end of input capacitor 100 and to lead GND.

A second end of each inductor 320 is connected to the anode end of a respective LED string 50. The cathode end of one LED string 50 is connected to a first end of sense resistor 80 and to a first end of isolation circuit 170, and a second end of sense resistor 80 is connected to lead GND, and to the cathode end of the remaining LED strings 50. A second end of isolation circuit 170 is connected to the input of control circuitry 430 and an output of control circuitry 430 is connected to a control input of electronically controlled switch 110, illustrated without limitation as the gate terminal.

In operation, when electronically controlled switch 110 is closed responsive to control circuitry 430, current flows through each of the LED strings 50 via non-dissipative balancer 30. When electronically controlled switch 110 is open, inductors 320 of non-dissipative balancer 310 discharge through the respective LED string 50 and unidirectional electronic valve 420. The timing of electronically controlled switch 110 is restricted to ensure complete discharge of inductors 320, so as to avoid saturation. Current through the various LED strings 50 is balanced by the operation of non-dissipative balancer 310, as described above, with the values of inductors 320 selected as described above. Control circuitry 430 maintains the timing of electronically controlled switch 110 so that the current through the LED string 50 connected to sense resistor 80 matches a target current, with the balance of LED strings 50 controlled by non-dissipative balancer 310 to have a matching current.

Buck converter 410 may be replaced with a direct buck converter, a forward converter, a half-bridge, full bridge or push-pull converter, wherein the electronically controlled switch 110 is placed on the return side of the DC input, as long as the discontinuous current operation of the inductor is maintained, without exceeding the scope.

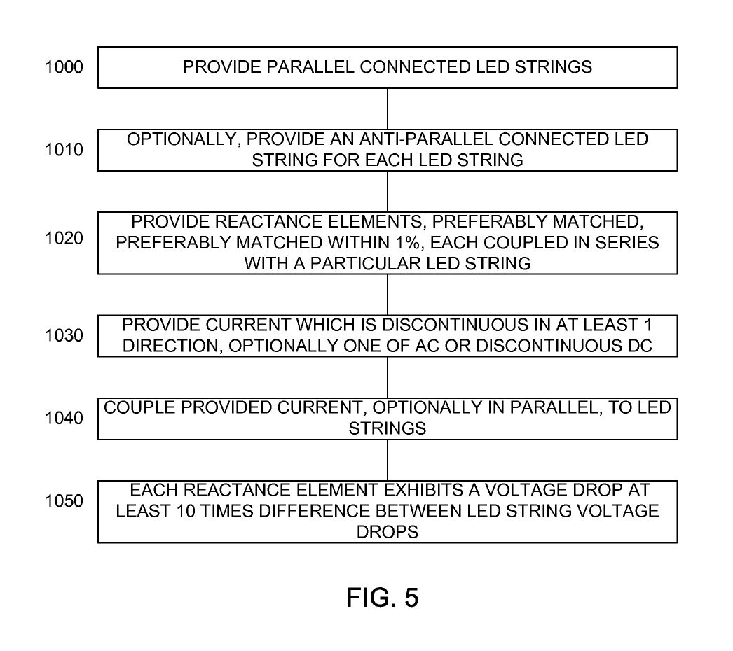

FIG. 5 illustrates a high level flow chart of an exemplary method of non-dissipative balanced driving for LED strings, such as LED strings 50. In stage 1000 a plurality of parallel connected LED strings are provided, and in optional stage 1010 for each of the provided LED strings of stage 1000 an anti-parallel LED string is provided and connected such the anode of the anti-parallel LED string is connected to the cathode of the respective LED string and the cathode of the anti-parallel LED string is connected to the anode of the respective LED strings. The LED string and anti-parallel LED string thus form an anti-parallel pair of LED strings.

In stage 1020 a plurality of reactance elements are provided. The reactance elements are preferably matched, and further preferably matched to exhibit a reactance within 1% of the reactance of the balance of the reactance elements. The reactance elements are each coupled in series with a particular LED string.

In stage 1030 a current is provided which is discontinuous in at least one direction. Optionally, the provided current is an alternating current. Optionally, the provided current is a discontinuous direct current, having an off period sufficient to allow discharge for the reactance element between successive on periods. In stage 1040 the provided current of stage 1030 is coupled to each of the series coupled LED strings and reactance elements, optionally in parallel.

In stage 1050, the provided reactance elements of stage 1020 are selected so as to exhibit a voltage drop across each of the series arranged reactance elements of stage 1020, responsive to the provided discontinuous current of stage 1030, at least 10 times greater than the maximum difference between the voltage drops among the provided plurality of LED strings of stage 1000.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described herein above. Rather the scope of the present invention is defined by the appended claims and includes both combinations and sub-combinations of the various features described hereinabove as well as variations and modifications thereof which would occur to persons skilled in the art upon reading the foregoing description and which are not in the prior art.

I claim:

1. A solid state lighting arrangement comprising:
a power source providing a current which is discontinuous in at least one direction;
a plurality of light emitting diode (LED) strings arranged to receive the provided current from said power source; and
a plurality of reactance elements, each of said plurality of reactance elements arranged in series with a particular one of said plurality of LED strings, such that current flowing from said power source through each of said LED strings creates a voltage drop across said series arranged reactance element,
wherein the voltage drop across each of said series arranged reactance elements responsive to the discontinuous current is at least 10 times greater than the maximum difference between the voltage drops among the plurality of LED strings.

2. The solid state lighting arrangement according to claim 1, wherein each of said plurality of reactance elements exhibits a reactance to the discontinuous current within 1% of the reactance of the balance of said plurality of reactance elements.

3. The solid state lighting arrangement according to claim 1, wherein said plurality of reactance elements are constituted of capacitors.

4. The solid state lighting arrangement according to claim 1, wherein said plurality of reactance elements are constituted of inductors.

5. The solid state lighting arrangement according to claim 1, further comprising a plurality of anti-parallel connected LED strings, the anode end of each of said anti-parallel connected LED strings coupled to the cathode end of a respective one of said plurality of LED strings and the cathode end of each of said anti-parallel connected LED strings coupled to the anode end of the respective one of said plurality of LED strings.

6. The solid state lighting arrangement according to claim 1, further comprising a plurality of full wave rectifiers, each of said plurality of full wave rectifiers arranged in series with a particular one of said plurality of LED strings such that the discontinuous current from said power source is rectified by the series arranged full wave rectifier so as to pass through the respective LED string irrespective of polarity of the discontinuous current provided by said power source.

7. The solid state lighting arrangement according to claim 1, wherein the provided discontinuous current is a discontinuous direct current.

8. The solid state lighting arrangement according to claim 1, wherein the provided discontinuous current is an alternating current.

9. The solid state lighting arrangement according to claim 1, wherein the arrangement of said plurality of light emitting diode strings to receive the provided current from said power source is a parallel arrangement.

10. A method of balanced driving for light emitting diode (LED) strings, the method comprising:
providing a plurality of light emitting diode (LED) strings;
providing a plurality of reactance elements, each of said provided reactance elements associated with a particular one of said provided plurality of LED strings;
providing a current which is discontinuous in at least one direction;
coupling said provided discontinuous current to the plurality of provided LED strings;
coupling each of said provided plurality of reactance elements in series with its respective associated LED string such that said provided discontinuous current coupled from said power source to said provided plurality of LED strings creates a voltage drop across each of said series arranged reactance elements; and
selecting said provided plurality of reactance elements such that the voltage drop across each of said series arranged reactance elements responsive to said provided discontinuous current is at least 10 times greater than the maximum difference between the voltage drops among the provided plurality of LED strings.

11. The method according to claim 10, wherein each of said provided plurality of reactance elements exhibits a reactance to the discontinuous current within 1% of the reactance of the balance of said provided plurality of reactance elements.

12. The method according to claim 10, wherein said provided plurality of reactance elements are constituted of capacitors.

13. The method according to claim 10, wherein said provided plurality of reactance elements are constituted of inductors.

14. The method according to claim 10, further comprising:
providing a plurality of anti-parallel connected LED strings;
coupling the anode end of each of said provided anti-parallel connected LED strings to the cathode end of a respective one of said plurality of LED strings; and
coupling the cathode end of each of said provided anti-parallel connected LED strings to the anode end of the respective one of said plurality of LED strings.

15. The method according to claim 10, further comprising:
providing a plurality of full wave rectifiers; and
arranging each of said provided plurality of full wave rectifiers in series with a particular one of said plurality of LED strings such that current from said power source is rectified by the series arranged full wave rectifier so as to pass through the respective LED string irrespective of polarity of said provided discontinuous current.

16. The method according to claim 10, wherein said provided discontinuous current is a discontinuous direct current.

17. The method according to claim 10, wherein said provided discontinuous current is an alternating current.

18. The method according to claim 10, wherein said provided plurality of light emitting diode strings are connected in parallel.

19. A method of balanced driving for light emitting diode (LED) strings, the method comprising:
providing a plurality of parallel connected light emitting diode (LED) strings;
providing a plurality of matched reactance elements each coupled in series with a particular one of said provided plurality of parallel connected LED strings;
providing a current which is discontinuous in at least one direction; and
coupling said provided discontinuous current in parallel to each of the plurality of series coupled LED strings and reactance element,
wherein said provided plurality of matched reactance elements is selected to exhibit a voltage drop across each of said series arranged reactance elements, responsive to said provided discontinuous current at least 10 times greater than the maximum difference between the voltage drops among the provided plurality of LED strings.

20. The method according to claim 19, wherein each of said provided plurality of reactance elements exhibits a reactance to the discontinuous current within 1% of the reactance of the balance of said provided plurality of reactance elements.
